(19) United States
(12) Patent Application Publication
(10) Pub. No.: US 2026/0308915 A1
(43) Pub. Date: Oct. 8, 2026

(54) FASTENING SYSTEM FOR WALLBOARD PANEL

(71) Applicant: CONVERGENT IDEAS LLC, OLNEY, MD (US)

(72) Inventor: FRANCESCA R. ONETO, OLNEY, MD (US)

(21) Appl. No.: 19/171,348

(22) Filed: Apr. 7, 2025

(51) Int. Cl. E04F 13/08; F16B 5/02

(52) U.S. Cl. CPC E04F 13/0805; F16B 5/0208

(57) ABSTRACT

A fastening system for a wallboard panel to wall framing studs has a base. The base has mounting structures. The mounting structure is constructed as a hole for the base to be secured by a standard fastener or is integrally formed as a threaded fastener. The base has projections formed on the base with interference members firmed on the projections. The interference members may be formed directly on the base. Various combinations of projections and interference members may be used concurrently.

### BACKGROUND

The present invention relates to interior wall installation, more specifically to a fastening system for a wallboard panel.

Wallboard panels made of gypsum are commonly utilized in building construction. These panels include a core of gypsum between face and backing sheets of paper. Many other materials have been proposed for wallboard panels.

Wallboard panels are typically mounted to framing stubs made of wood or steel. The wallboard is placed in position and then a screw fastener is applied through the exposed face of the wallboard panel and into the framing stud.

One problem installers face with this method is finding the framing stud for attaching the fastener in the between the outer edges of the wallboard panel. If the screw fastener is positioned at a point not aligned with the framing stud, the screw fastener creates a needless weakness in the wallboard panel.

Another problem installers face with the standard method of attaching the wallboard to the studs is after the wallboard is attached, the installer must fill the hole with material that hardens to create a smooth surface.

Thus, there is a need for a wallboard fastener system eliminating the need for prior determination of the framing studs prior to applying the wallboard fasteners as well as increasing productivity by eliminating the need for patching the wallboard panel to cover fastener.

### BRIEF SUMMARY OF THE INVENTION

It is an object of this invention to provide a fastener configured to be mounted on the framing studs and grip the back side of the wallboard.

It is a further object of this invention to provide a fastener to eliminate post wallboard repair after installation.

It is a further object of this invention to provide a fastener that decreases installation time of the wallboard.

It is a further object of this invention to provide a fastener that eliminates the risk of damaging the surface of an installed wallboard caused by a fastener such as over-sinking.

It is an object of this invention to provide a wallboard attachment device with a mounting structure for securing the wallboard attachment device to a stud and at least one interference structure for engaging the wallboard.

It is an object of this invention to provide a projection member positioned between the base and the at least one interference member, thereby providing an offset for the interference member as well as providing additional surface area for additional interference members.

These and other objects are preferably accomplished by providing a fastener comprising a base having mounting members for being fixed to framing studs, projections extending from the base for penetration into the wallboard, and harpoon-like spikes projecting from the base for securing the wallboard.

These and other aspects of this invention will become apparent to those skilled in the art after reviewing the following description of the invention.

### BRIEF DESCRIPTION OF THE DRAWINGS

The above-mentioned features and objects of the present disclosure will become more apparent with reference to the following description taken in conjunction with the accompanying drawings and images in which:

FIG. 1 is a top view of a wallboard attachment device in accordance with a first embodiment of the present invention having pyramid projections and spike interference members;

FIG. 2 is a side view of the wallboard attachment device in accordance with the first embodiment of the present invention;

FIG. 3 is a side view of the wallboard attachment device installed with the use of an anchoring element (e.g., a screw) in accordance with the present invention;

FIG. 4 is a perspective view of the wallboard attachment device in accordance with a second embodiment of the present invention having cone projections and spike interference members;

FIG. 5 is a side view of the wallboard attachment device in accordance with the second embodiment of the present invention;

FIG. 6 is a perspective view of the wallboard attachment device in accordance with a third embodiment of the present invention having cylinder projections and spike interference members;

FIG. 7 is a side view of the wallboard attachment device in accordance with the third embodiment of the present invention;

FIG. 8 is a perspective view of the wallboard attachment device in accordance with a fourth embodiment of the present invention having tube projections and spike interference members;

FIG. 9 is a side view of the wallboard attachment device in accordance with the fourth embodiment of the present invention;

FIG. 10 is a perspective view of the wallboard attachment device in accordance with a fifth embodiment of the present invention having pin projections and spike interference members;

FIG. 11 is a side view of the wallboard attachment device in accordance with the fifth embodiment of the present invention;

FIG. 12 is a perspective view of the wallboard attachment device in accordance with a sixth embodiment of the present invention having barbed pin projections and spike interference members;

FIG. 13 is a side view of the wallboard attachment device in accordance with the sixth embodiment of the present invention;

FIG. 14 is a side view of a spike interference member with a barb tip;

FIG. 15A is a side view of a hook interference member with a barb tip;

FIG. 15B is a side view of a hook interference member with a barb tip;

FIG. 16 is a perspective view of the wallboard attachment device in accordance with a seventh embodiment of the present invention having tube projections and blade interference members;

FIG. 17 is a top view of the wallboard attachment device in accordance with the seventh embodiment of the present invention;

FIG. 18 is a top view of an eight embodiment having pointed blades interference members;

FIG. 19 is a perspective view of the wallboard attachment device with a long base and multiple interference members;

FIG. 19A is a side view of the wallboard attachment device in accordance with an ninth embodiment of the present invention having pointed blade interference members surrounding a pin projection;

FIG. 19B is a top view of the wallboard attachment device in accordance with the ninth embodiment of the present invention;

FIGS. 20A and 20B are a side view and a top view respectively of the wallboard attachment device in accordance with the tenth embodiment of the present invention having a threaded fastening portion and blade interference members;

FIGS. 21A and 21B are a top view and a side view respectively of the wallboard attachment device in accordance with an eleventh embodiment of the present invention having a circular base and blade interference members;

FIG. 22 illustrates a collection of bases utilized in the embodiments of the wallboard attachment device;

FIG. 23 illustrates a collection of projections utilized in the embodiments of the wallboard attachment device; and

FIG. 24 illustrates a collection of interference members utilized in the embodiments of the wallboard attachment device.

### DETAILED DESCRIPTION OF THE INVENTION

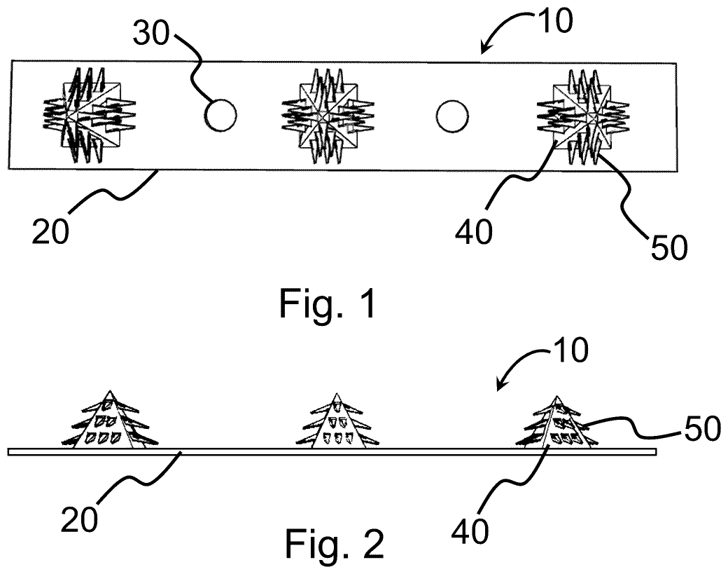

FIGS. 1-3 illustrates a wallboard attachment device 10 in accordance with a first embodiment comprising a base 20 with two mounting structures or holes 30. As shown in FIGS. 1 and 2, the wallboard attachment device 10 includes three projections 40 extending from the base. In this embodiment, the projections 40 are in the form of pyramids. Multiple interference members 50 extend from each face of each of the pyramids. In this embodiment, the interference members 50 are in the form of spikes.

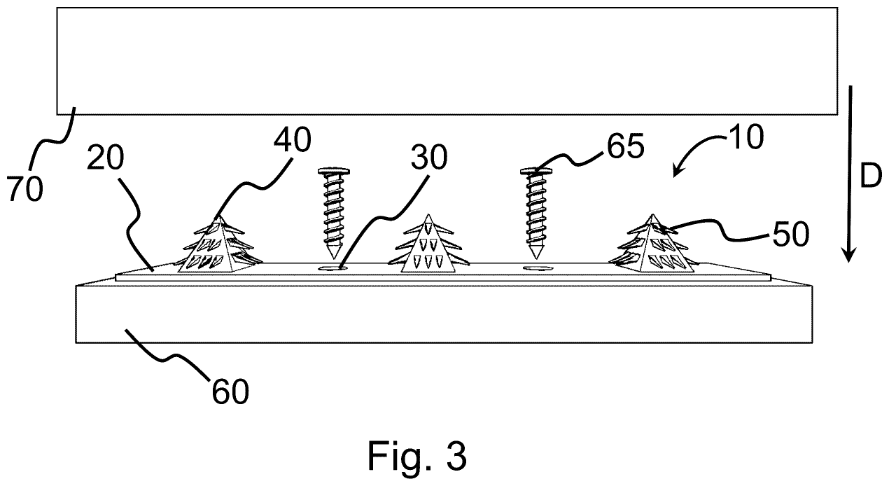

FIG. 3 depicts the wallboard attachment device 10 of the first embodiment installed on wall studs 60 with two fasteners 65. The wallboard 70 is affixed to the wallboard attachment device 10 with the projections 40 and interference members 50 embedded in the wallboard 70.

In operation, multiple wallboard attachment devices 10 are attached to wall studs 60. With multiple wallboard attachment devices 10 secured to the wall studs 60, the wallboard 70 is brought into position for attachment. With the wallboard 70 in position, the wallboard 70 is pushed onto the projections 40 with interference members 50. The projections 40 and spikes 50 displace the material within the wallboard 70 around the interference members 50 so that the interference members 50 grips the wallboard 70 at retains the wallboard 70 in a secure manner against the studs 60.

The following embodiments demonstrate various geometries of the projections.

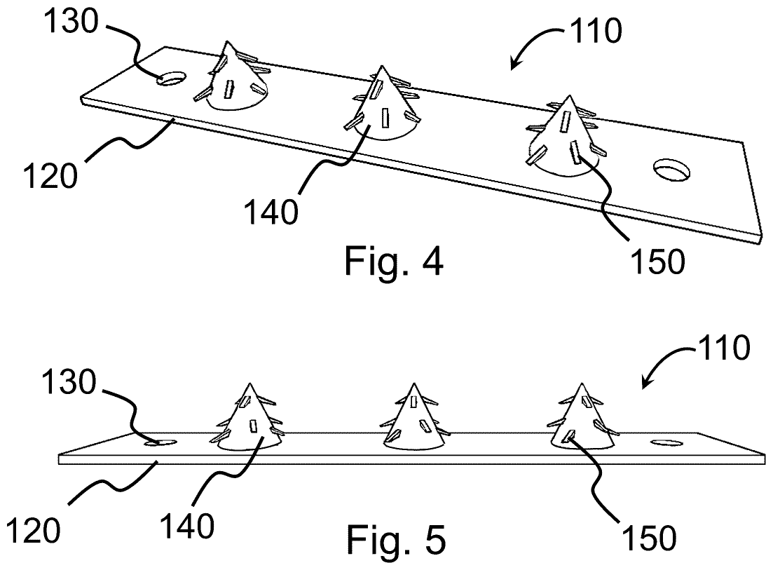

FIGS. 4 and 5 illustrate a wallboard attachment device 110 in accordance with a second embodiment comprising a base 120 with two mounting structures or holes 130. As shown in FIG. 4, the wallboard attachment device 110 includes three projections 140 extending from the base. In this embodiment, the projections 140 are in the form of cones. Multiple interference members, such as spikes, 150 extend from the conic surface of each of the cones.

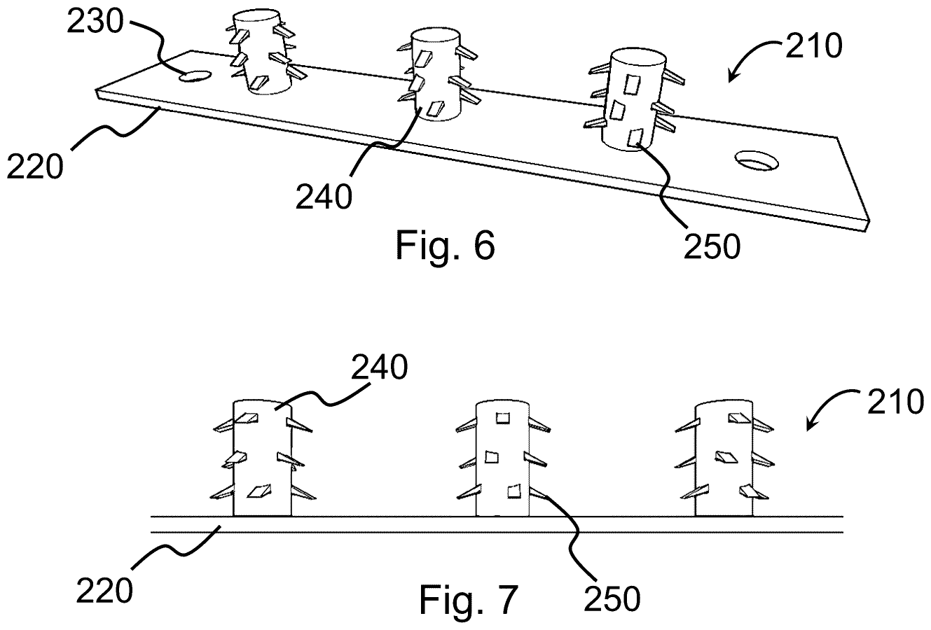

FIGS. 6 and 7 illustrate a wallboard attachment device 210 in accordance with a third embodiment comprising a base 220 with two mounting structures or holes 230. As shown in FIG. 6, the wallboard attachment device 210 includes three projections 240 extending from the base. In this embodiment, the projections 240 are in the form of cylinders. Multiple interference members, such as spikes, 250 extend from the cylindric surface of each of the cylinders.

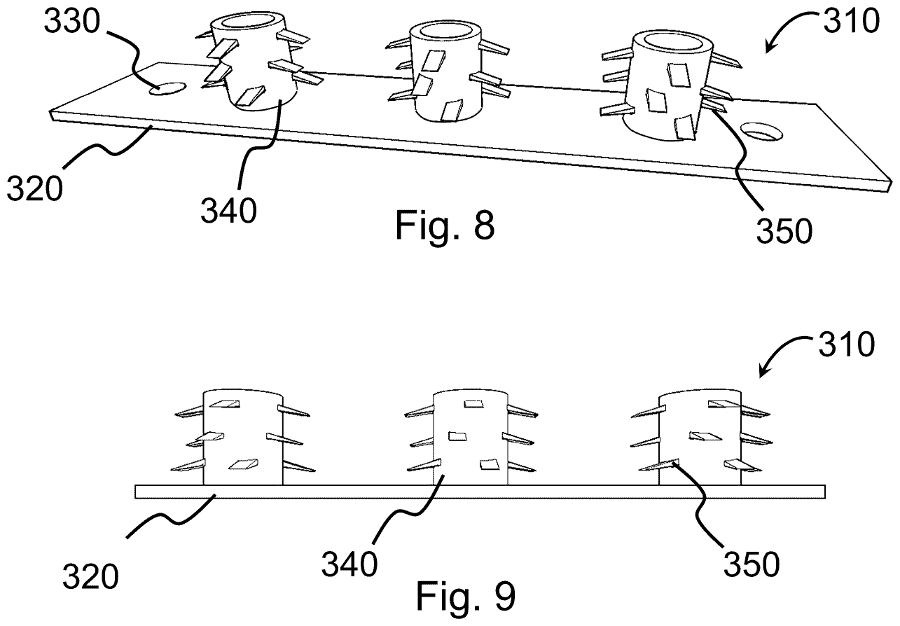

FIGS. 8 and 9 illustrate a wallboard attachment device 310 in accordance with a fourth embodiment comprising a base 320 with two mounting structures or holes 330. As shown in FIG. 8, the wallboard attachment device 310 includes three projections 340 extending from the base. In this embodiment, the projections 340 are in the form of tubes. Multiple interference members, such as spikes, 350 extend from the outer cylindric surface of each of the tubes.

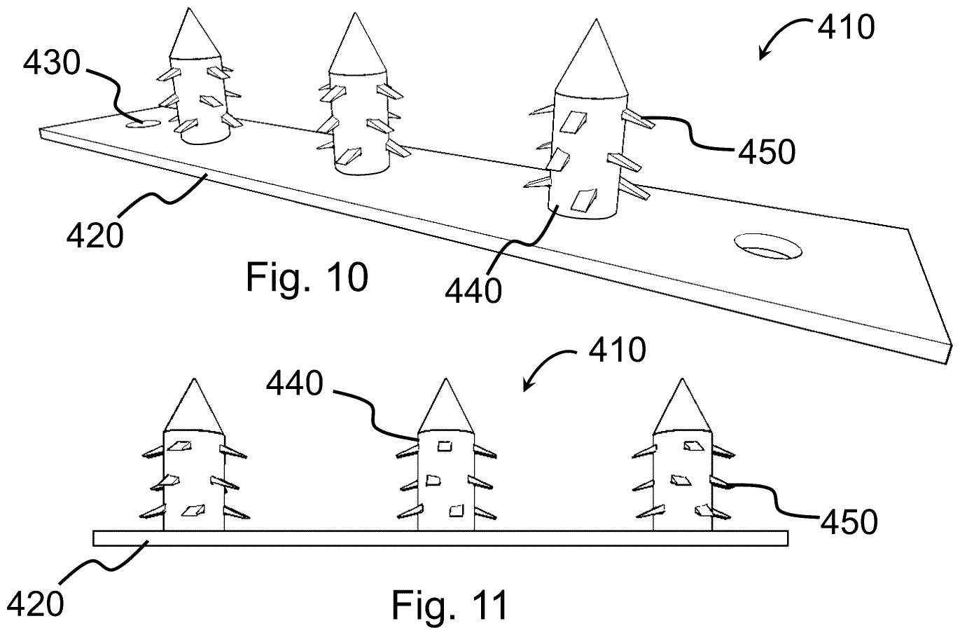

FIGS. 10 and 11 illustrate a wallboard attachment device 410 in accordance with a fifth embodiment comprising a base 420 with two mounting structures or holes 430. As shown in FIG. 10, the wallboard attachment device 410 includes three projections 440 extending from the base. In this embodiment, the projections 440 are in the form of pins. Multiple interference members, such as spikes, 450 extend from the outer cylindric surface of each of the pins.

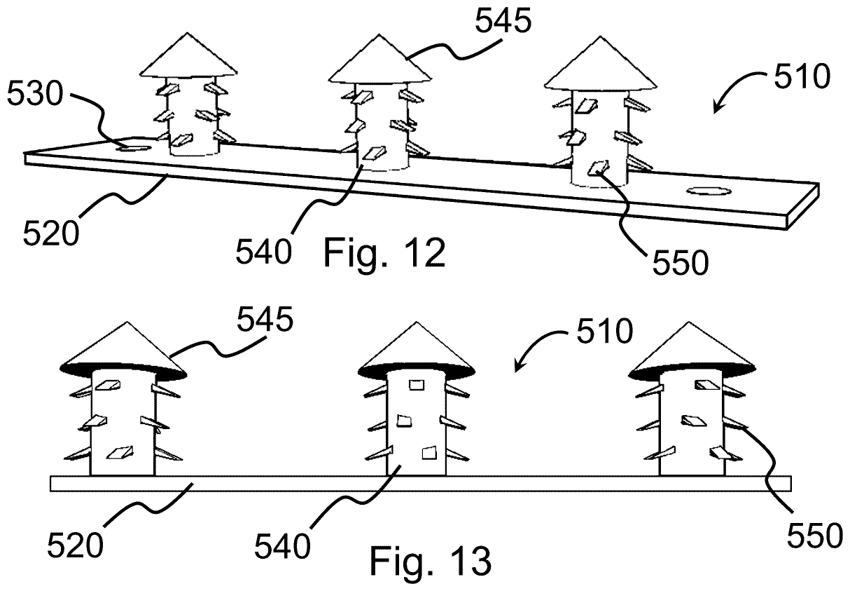

FIGS. 12 and 13 illustrate a wallboard attachment device 510 in accordance with a sixth embodiment comprising a base 520 with two mounting structures or holes 530. As shown in FIG. 12, the wallboard attachment device 510 includes three projections 540 extending from the base. In this embodiment, the projections 540 are in the form of barbed pins with a barbed tip 545. Multiple interference members, such as spikes, 550 extend from the outer cylindric surface of each of the barbed pins.

The barbed pins may have a continuous barb as shown in the FIGS. 12 and 13 or discontinuous barb alternating between the barb of FIGS. 12 and 13 and the transition of the cone shape and cylinder of the pin shape of FIGS. 10 and 11.

In even more embodiments, different geometries of the interference members are described in the following paragraphs. The interference members may be used in place of the spikes described in the previous paragraphs.

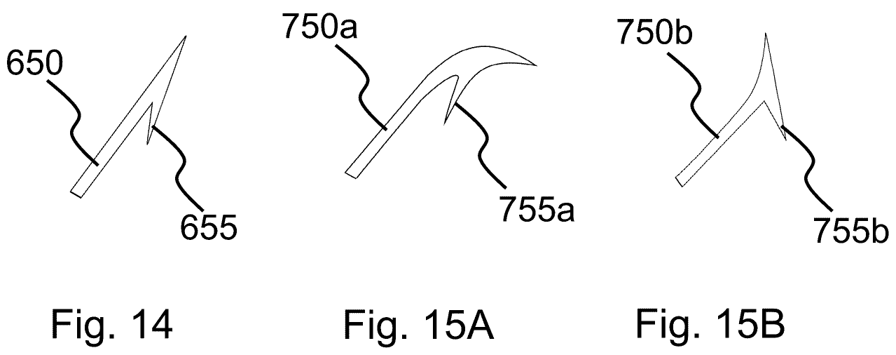

As shown in FIG. 14, each of the interference structures 650, spike may end with a barb tip 655.

In FIG. 15A, interference member 750a is shown in the form of a hook. Each interference member, hook, 750a may also include a barbed tip 755a.

In FIG. 15B, interference member 750b is shown in the form of a hook. Each interference member, hook, 750b may also include a barbed tip 755b.

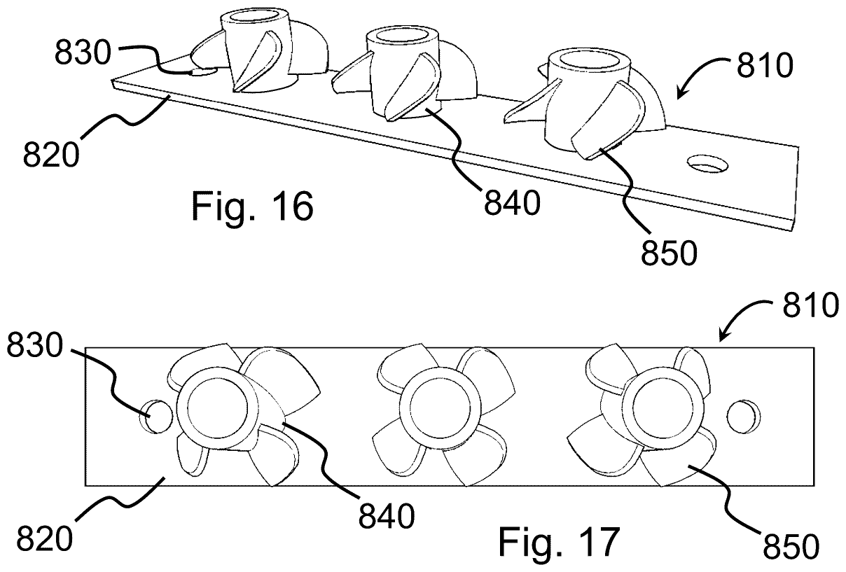

In FIGS. 16 and 17, the interference member 850 is shown in the form of a blade. In one example, interference members 850 is attached to the projections 840, tubes. The interference members, blades, 850 extend from the outer surface of the projections 840 at an angle. The angle of the interference members 850 is selected to permit slicing into the wallboard 70 (not shown) without crushing the wallboard 70. The blades 850 discussed may be incorporated on various projections with the tubes being shown merely as an example.

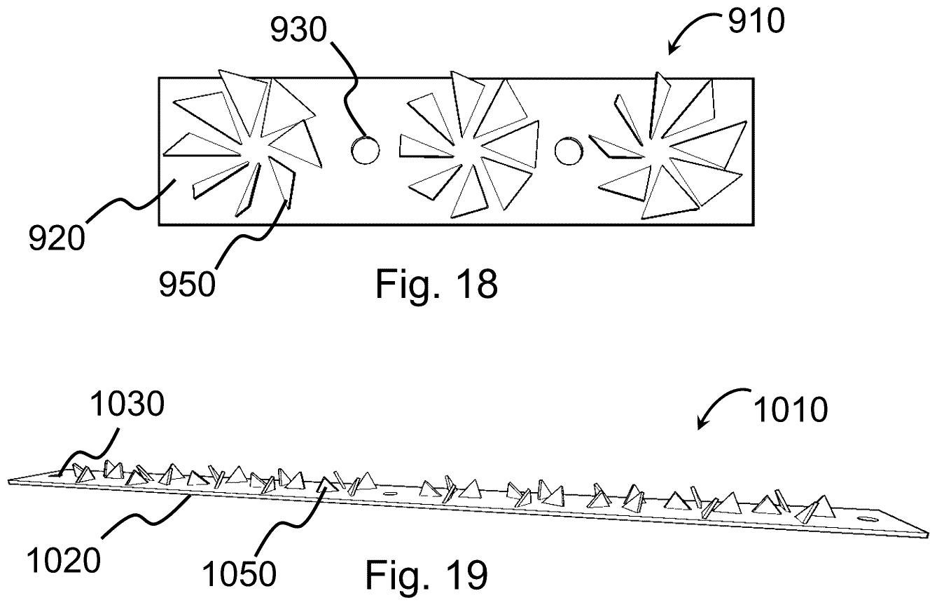

In another variation of the wallboard attachment device, shown in FIG. 18, wallboard attachment device 910 is a simplified system where a base 920 has the interference structure 940 mounted directly to the base 920 without including a projection. As shown in FIG. 18, the interference structure 940 are blades. In other embodiments the interference structure 940 can be any one or a mixture of spikes, hooks or blades. Each of the interference structures may end with a barb tip.

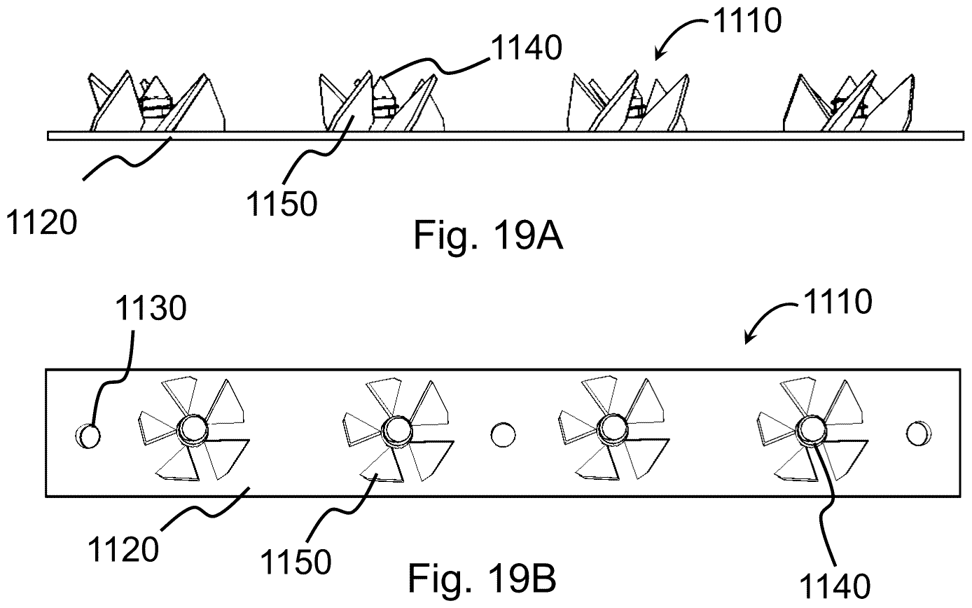

In other embodiments, as shown in FIG. 19 wallboard attachment device 1010 has a long base 1020 with multiple interference structures 1040 are spaced evenly along the length of the base 1020. In this example, the interference structures 1040 are blades. A top view of this embodiment is similar to the embodiment shown in FIG. 18.

In FIGS. 19A and 19B, the interference member 1150 is shown in the form of a blade. In this embodiment, interference members 1150 are attached to the base 1120 and positioned around a projection 1140, pin. The pin 1140 incorporates helical threads on the side surface.

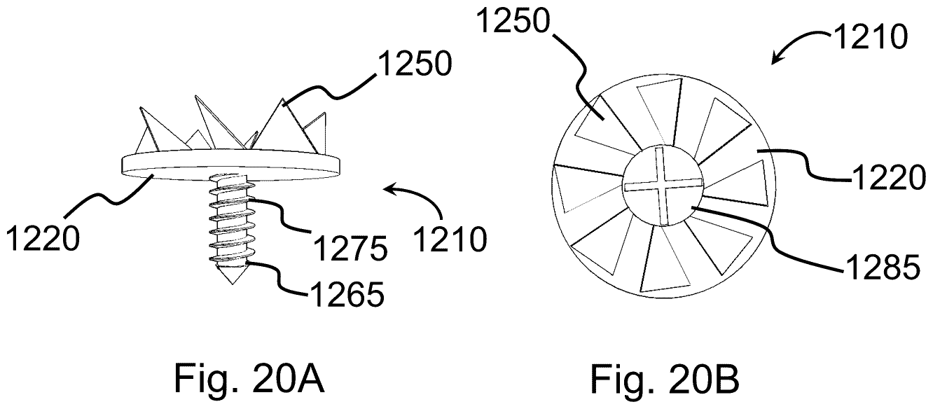

Referring to FIGS. 20A and 20B, in a further variation of the wallboard attachment device 1210, the wallboard attachment device is a further simplified system where the interference structures 1240, blades, are mounted on a fastening device 1265. The fastening device includes a threaded portion 1275 and a head 1220. The interference structures 1240 are mounted on the head 1220 about a fixation interface 1285. The fixation interface 1285 is one of any structure such as a slot, a indented cross shape (Phillips®), indented hexagon shape (Allen®), indented star shape (torx®), etc.

Alternate interference structures 1240, such as spikes or hooks, may be utilized. Each of the interference structures 1240 may include a barbed tip.

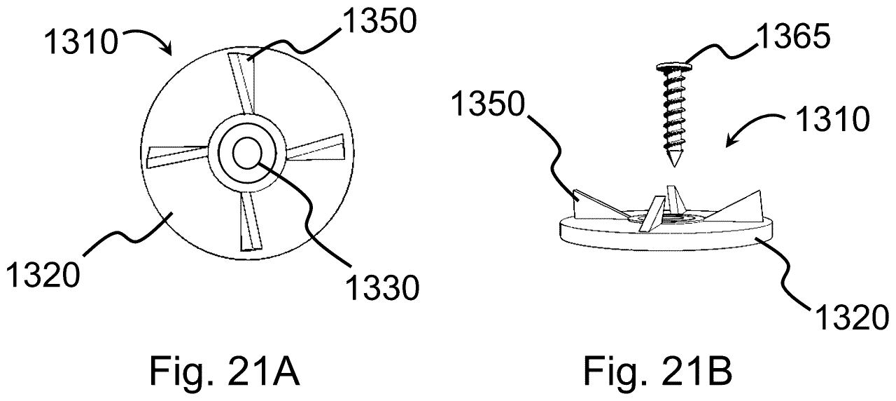

Referring to FIG. 21, in a further embodiment of the wallboard attachment device 1310, the interference structures, blades, 1340 are mounted on a circular base 1320 with a single mounting hole 1330 in the center of the base 1320.

In operation, the circular base 1320 is placed on stud 60. Fastener 1365 is fixed to the stud 60 (not shown) through the mounting hole 1330 with proper sizing to retain the circular base 1320. Multiple wallboard attachment devices 1310 are mounted positioned on multiple studs 60. With multiple wallboard attachment devices 1310 secured to the wall studs 60, the wallboard 70 (not shown) is brought into position for attachment. With the wallboard 70 in position, the wallboard 70 is pushed onto the interference members 1340. The interference members, blades, 1340 displace the material within the wallboard 70 around the interference members 1340. Additionally, as the interference members 1340 enter the wallboard 70, the wallboard attachment devices 1310 may rotate slightly about the fastener 1365. The combination of the interference members 1340 and the slight rotation of the of the wallboard attachment device 1310 provides a firm grip of the wallboard 70 at retains the wallboard 70 in a secure manner against the studs 60. As with the previous embodiments, the interference members may be substituted for any of the interference members previously discussed. The interference members may also include a barb on each tip.

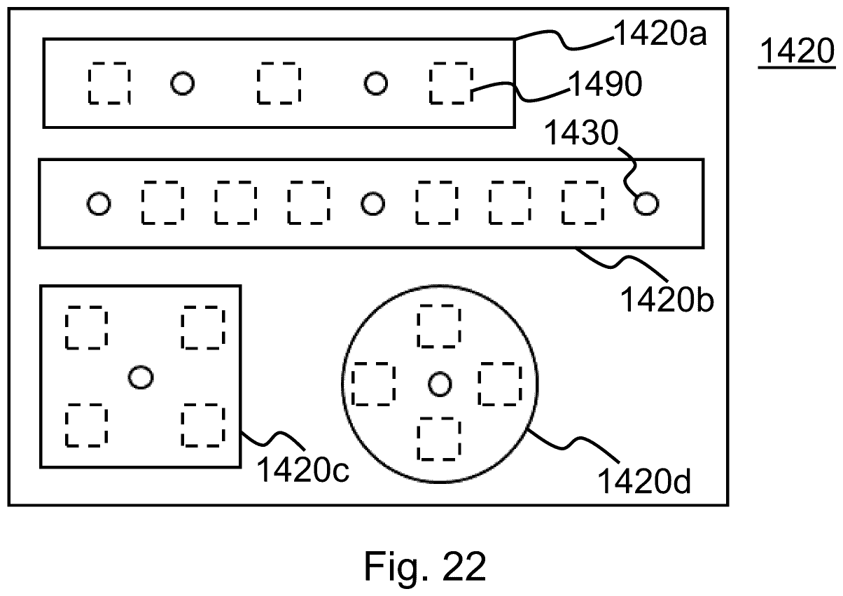

A collection of bases 1420 is shown in FIG. 22. This collection 1420 include a short rectangular base 1420a, a long rectangular base 1420b, a square base 1420c and a circular base 1420d. Each of these bases utilizes standard fasteners to secure the base to the studs 60 (not shown) through respective fastener holes 1430. Each base is illustrated with a region 1490 where projections, interference members or combination thereof may be placed.

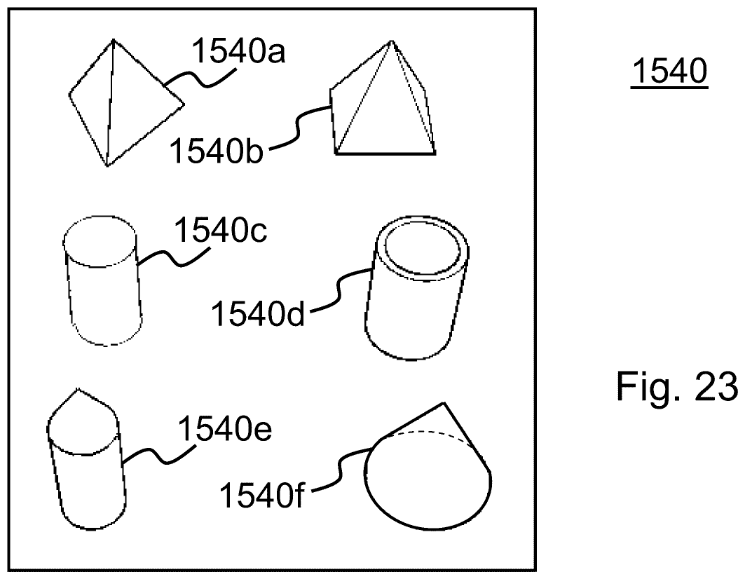

A collection of projections 1540 is shown in FIG. 23. These projections 1540 include a tetrahedron 1540a, pyramid 1540b, thin cylinder 1540c, tube 1540d, pin 1540e, and cone 1540f. Additional geometries may include the initial point of impact being a point, or a knife edge. The knife edge may be straight or curve. The straight or curved knife edge may form an open or closed loop. Additional geometries may be incorporated in the side faces of the projections including straight or spiraled flutes, and may include helical threads in the side faces.

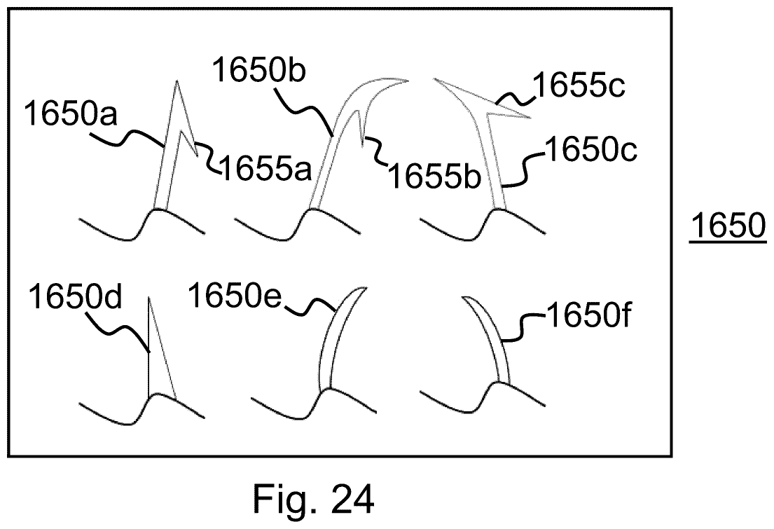

A collection of interference members 1650 is shown in FIG. 24. These interference members 1650 include spike 1650a, and hooks 1650b, 1650c. Each of these are shown with a barbed tip. Spike 1650d, and hooks 1650e, 1650f are shown without a barbed tip. Further interference members that may be incorporated are blades previously described. Additionally, blades may incorporate knife edges on the leading edge of the blade or incorporate one or more barbs along the leading edge.

Alternate embodiments include random or other periodic placement of the interference structures on the base, random or other periodic placement of the projections on the base and random or other periodic placement of the interference structures on the projections.

Further embodiments include utilizing two or more different projections and/or interference structures.

What is claimed is:

1. A wallboard attachment device comprising:
a base with at least one mounting structure; and
at least one interference member extending from the base.

2. The wallboard attachment device of claim 1, wherein the at least one interference member is composed of a resilient material.

3. The wallboard attachment device of claim 2, wherein the resilient material of the at least one interference member provides resilience to the at least one interference member to deflect from an initial position with a blunt force and to restore to the initial position after the blunt force.

4. The wallboard attachment device of claim 1, wherein the at least one interference member is composed of a rigid material.

5. The wallboard attachment device of claim 1, wherein the mounting structure is a mounting hole for the insertion of a threaded fastener.

6. The wallboard attachment device of claim 1 further including at least one projection member positioned between the base and the at least one interference member with the at least one projection member extending from the base, and the at least one interference member extending from the at least one projection member extending from the base.

7. The wallboard attachment device of claim 1, wherein the base is selected from the group consisting of a square base, a rectangular base, and a circular base.

8. The wallboard attachment device of claim 7, wherein the rectangular base incorporates two or more projections extending from the rectangular base.

9. The wallboard attachment device of claim 6, wherein the at least one projection includes a sharp apex.

10. The wallboard attachment device of claim 6, wherein the at least one projection is selected from the group consisting of a pyramid, a cone, a cylinder, a tube, a pin, and a tetrahedron.

11. The wallboard attachment device of claim 1, wherein the at least one interference member is selected from the group consisting of a spike, a hook, and a blade.

12. The wallboard attachment device of claim 11, wherein the at least one interference member includes a barbed tip.

13. The wallboard attachment device of claim 6, wherein the at least one projection includes at least one straight flute in a side of the at least one projection.

14. The wallboard attachment device of claim 6, wherein the at least one projection includes at least one curved flute in a side of the at least one projection.

15. The wallboard attachment device of claim 6, wherein the at least one projection includes a continuous spiral groove about the at least one projection.

16. The wallboard attachment device of claim 1, wherein the mounting structure is a threaded fastener extending from the base in a direction opposite to the at least one interference member extending from the base.

17. The wallboard attachment device of claim 16, wherein the base is the head of the threaded fastener with the at least one interference member extending from the outer periphery of the head and a threaded fastener driving interface at the center of the head.

18. The wallboard attachment device of claim 17, wherein the fastener driving interface is selected from the group consisting of a slot, an indented cross, an indented hexagon, and an indented star shape.

19. The wallboard attachment device of claim 1 further including at least one projection member extending from the base and the at least one interference member extending from the base.

20. The wallboard attachment device of claim 19, wherein the at least one projection is selected from the group consisting of a pyramid, a cone, a cylinder, a tube, a pin, and a tetrahedron; and the at least one interference member is selected from the group consisting of a spike, a hook, and a blade.
